(19) United States
(12) Patent Application Publication
(10) Pub. No.: US 2005/0015637 A1
(43) Pub. Date: Jan. 20, 2005

(54) Data processing system

(76) Inventors: Josephus Theodorus Johannes Van Eijndhoven, Eindhoven (NL); Evert-Jan Daniel Pol, Eindhoven (NL); Martijn Johan Rutten, Eindhoven (NL); Om Prakash Gangwal, Eindhoven (NL)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(21) Appl. No.: 10/498,445

(22) PCT Filed: Dec. 5, 2002
(86) PCT No.: PCT/IB02/05208

(30) Foreign Application Priority Data
Dec. 14, 2001 (EP) 01204885.6

(51) Int. Cl. G06F 1/12

(52) U.S. Cl. 713/400

(57) ABSTRACT

A data processing system is claimed which comprises a plurality of processors (12a, 12b, 12c) which communicate data streams with each other via a shared memory (10). The data processing system comprises processor synchronization means (18), for synchronizing the processors (12a-c) when passing the stream of data objects. For that purpose the processors are capable of issuing synchronization commands (Ca-c) to the synchronization means (18). At least one of the processors (12a) comprises a cache memory (184a), and the synchronization means (18) initiate a cache operation (CCa) in response to a synchronization commands (Ca).

The invention relates to a data processing system having multiple processors.

A heterogeneous multiprocessor architecture for high performance, data-dependent media processing e.g. for high-definition MPEG decoding is known. Media processing applications can be specified as a set of concurrently executing tasks that exchange information solely by unidirectional streams of data. G. Kahn introduced a formal model of such applications already in 1974, ‘The Semantics of a Simple Language for Parallel Programming’, Proc. of the IFIP congress 74, August 5-10, Stockholm, Sweden, North-Holland publ. Co, 1974, pp. 471-475 followed by an operational description by Kahn and MacQueen in 1977, ‘Co-routines and Networks of Parallel Programming’, Information Processing 77, B. Gilchhirst (Ed.), North-Holland publ., 1977, pp 993-998. This formal model is now commonly referred to as a Kahn Process Network.

An application is known as a set of concurrently executable tasks. Information can only be exchanged between tasks by unidirectional streams of data. Tasks should communicate only deterministically by means of a read and write process regarding predefined data streams. The data streams are buffered on the basis of a FIFO behaviour. Due to the buffering two tasks communicating through a stream do not have to synchronise on individual read or write processes

In stream processing, successive operations on a stream of data are performed by different processors. For example a first stream might consist of pixel values of an image, that are processed by a first processor to produce a second stream of blocks of DCT (Discrete Cosine Transformation) coefficients of 8×8 blocks of pixels. A second processor might process the blocks of DCT coefficients to produce a stream of blocks of selected and compressed coefficients for each block of DCT coefficients.

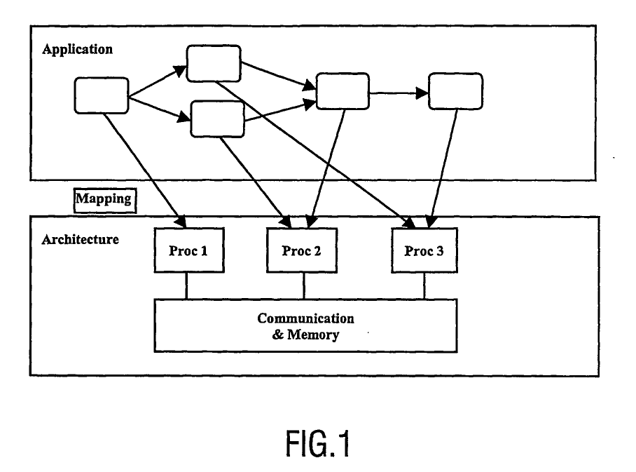

FIG. 1 shows a illustration of the mapping of an application to a processor as known from the prior art. In order to realise data stream processing a number of processors are provided, each capable of performing a particular operation repeatedly, each time using data from a next data object from a stream of data objects and/or producing a next data object in such a stream. The stres pass from one processor to another, so that the stream produced by a first processor can be processed by a second processor and so on. One mechanism of passing data from a first to a second processor is by writing the data blocks produced by the first processor into the memory.

The data streams in the network are buffered. Each buffer is realised as a FIFO, with precisely one writer and one or more readers. Due to this buffering, the writer and readers do not need to mutually synchronize individual read and write actions on the channel. Reading from a channel with insufficient data available causes the reading task to stall. The coprocessors can be dedicated hardware function units which are only weakly programmable. All coprocessors run in parallel and execute their own thread of control. Together they execute a Kahn-style application, where each task is mapped to a single coprocessor. The coprocessors allow multi-tasking, i.e., multiple Kahn tasks can be mapped onto a single coprocessor. The processors in such a system are provided with caches so as to reduce conflicts between processors which attempt the common memory. However, it is necessary to maintain the content of the caches coherent with the content of the memory which is shared by the processor.

Known methods for maintaining cache coherency are bus snooping and cache write through.

According to the first method each cache has a controller which observes the transactions to the memory, and updates its state accordingly.

According to the cache write through method each modification of the content of the memory is broadcasted to each of the caches.

Both methods require a significant amount of overhead.

It is therefore an object of the invention to improve the operation of a Kahn-style data processing system. A data processing system in accordance therewith is claimed in claim 1. In the data processing system according to the invention cache coherency is maintained by the synchronization means. In order to maintain cache coherency the synchronization means perform cache operations in response to the synchronization commands issued by the processors. This has the advantage that cache coherency is simply maintained as a side effect of the synchronization mechanism.

The synchronization means may be implemented in different ways. They could be implemented as a central synchronization processor, e.g. in the form of micro processor on which a program is running or in the form of dedicated hardware. Otherwise the synchronization processor may be implemented as a set of synchronization units, a respective synchronization unit being assigned to each processor and the synchronization units being arranged to communicate to each other via a token ring, or a bus.

According to the embodiment of claim 2 the synchronization means initiate an invalidate operation in response to an inquiry of the reading processor. If the reading processor issues an inquiry, i.e. requires access to a portion of memory in which it intends to read new data objects generated by a writing processor, it is possible that the corresponding portion in the cache memory is not yet coherent with the memory. Invalidating the corresponding portion in the cache is a pessimistic but safe operation.

According to the embodiment of claim 3 the synchronization means initiate a flush operation in response to a commit of the writing processor. If the writing processor issues a commit it releases a number of data objects for further processing by the reading processor. By executing a flush operation upon this commit the synchronization means achieve that the memory is coherent with the cache of the writing processor when the reading processor intends to further process the data objects.

According to the embodiment of claim 4 the synchronization means initiate a prefetch operation in response to an inquiry of the reading processor. The inquiry of the reading processor indicates that it intends to process the data objects in the memory. By means of the prefetch operation the cache of the reading processor is already coherent at the moment that the reading processor really starts to read data objects therefrom.

According to again another embodiment as claimed in claim 5 the synchronization means initiate a prefetch operation of the cache of the reading processor in response to a commit of the writing processor. This embodiment has the advantage that it provides for a coherence of the cache of the reading processor as soon as the new data objects have become available.

These and other aspects of the invention are described in more detail with reference to the drawings, the figures showing:

FIG. 1 an illustration of the mapping of an application to a processor according to the prior art;

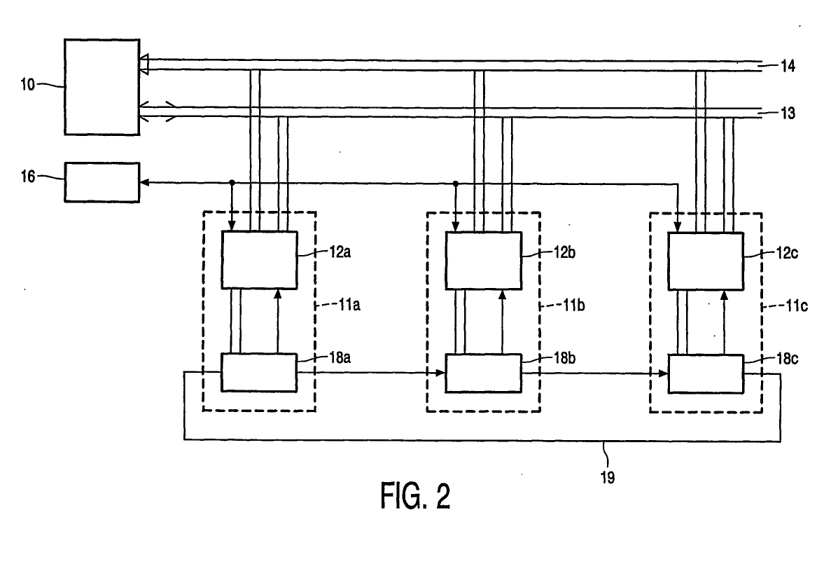

FIG. 2 a schematic block diagram of an architecture of a stream based processing system;

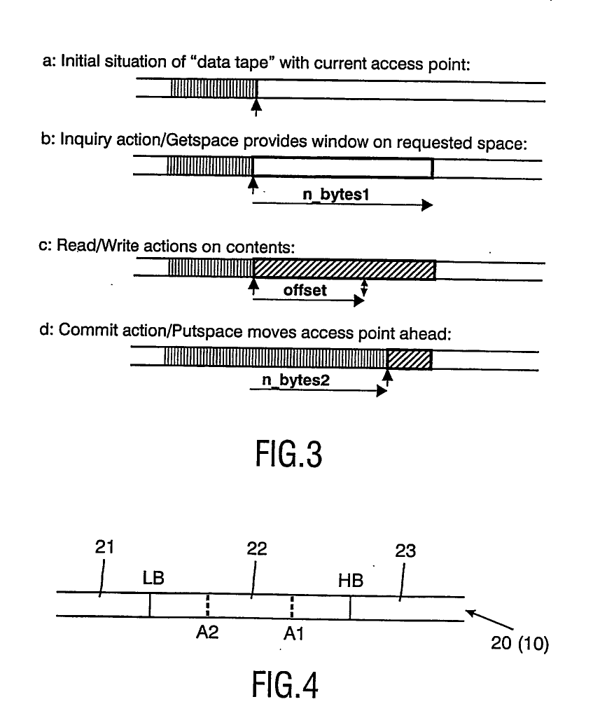

FIG. 3 an illustration of the synchronising operation and an I/O operation in the system of FIG. 2;

FIG. 4a schematic diagram of a shared memory

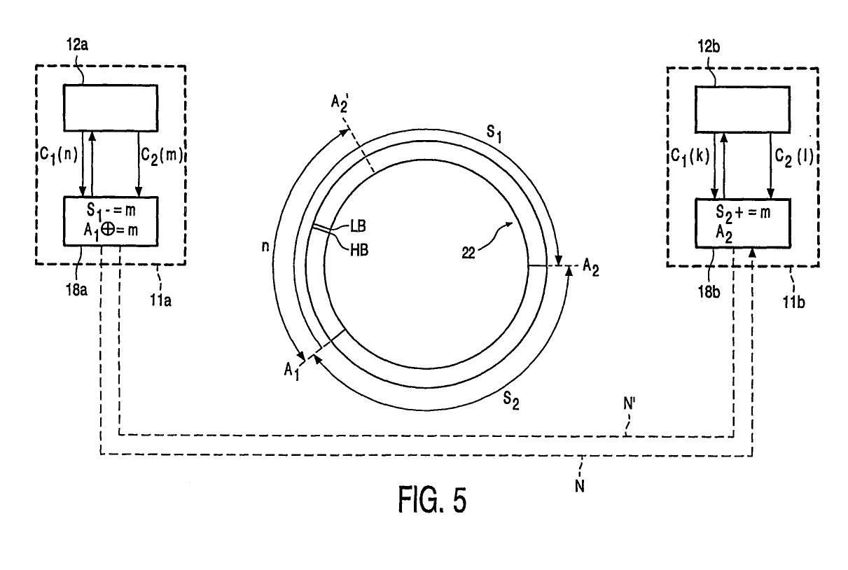

FIG. 5 a mechanism of updating local space values in each administration unit according to FIG. 2 using the memory of FIG. 4;

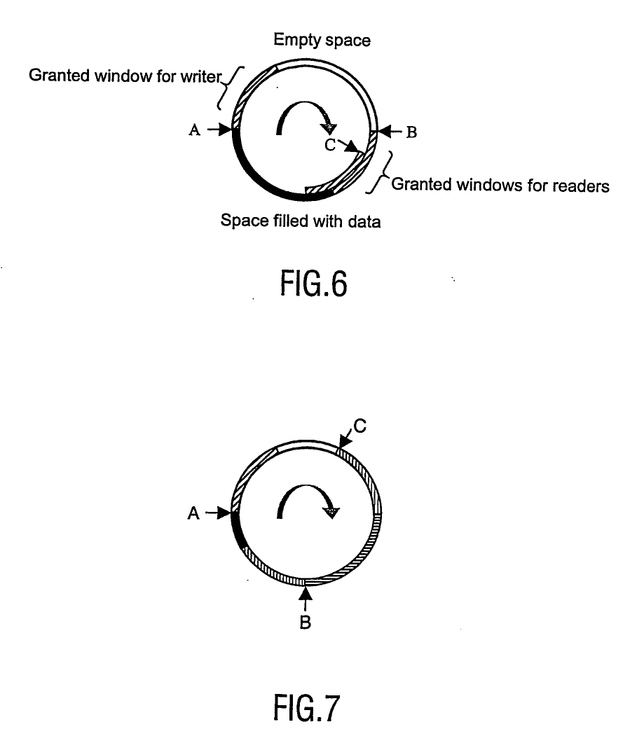

FIG. 6 an illustration of the FIFO buffer with a single writer and multiple readers;

FIG. 7 a finite memory buffer implementation for a three-station stream;

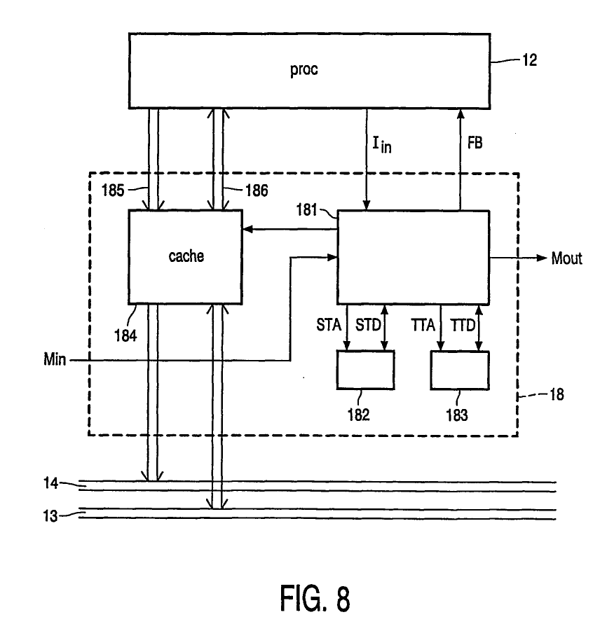

FIG. 8a processor forming part of the processing system in more detail; and

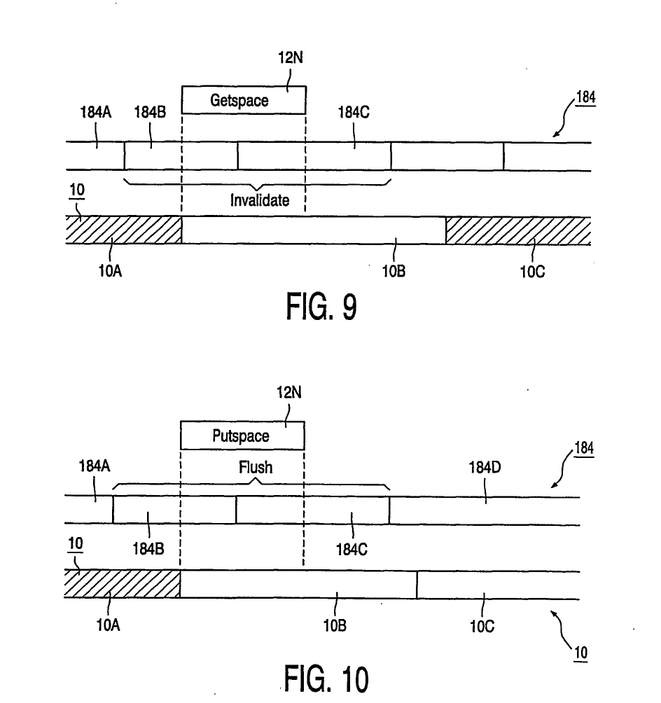

FIG. 9A-9C an illustration of reading and administrating the validity of data in a cache;

FIG. 10 a second embodiment of the processing system according to the invention.

FIG. 2 shows a processing system according to the invention. The system contains a memory 10, a number of processors 11a, 11b, 11c and an arbiter 16. The processors 11a-c each comprise a computational unit 12a, 12b, 12c and an administration unit 18a, 18b, 18c. Three processors 11a, 11b, 11c are shown by way of example, but in practice any number of processors may be used. The processors 11a-c are connected to the memory 10 via an address bus 14 and a data bus 13. The processors 11a-c are connected to the arbiter 16 and they are connected to each other via a synchronization channel comprising the administration units 18a-c which are coupled to each other via a communication network 19, such as a token ring.

Preferably, the processors 11a-c are dedicated processors, each specialized to perform a limited range of stream processing tasks efficiently. That is, each processor is arranged to apply the same processing operation repeatedly to successive data objects received via data bus 13. The processors 11a-c may each perform a different task or function, such as variable length decoding, runlength decoding, motion compensation, image scaling or performing a DCT transformation. Also programmable processors may be included, such as a TriMedia, or a MIPS-processor.

In operation each processor 11a-c executes operations on one or more data streams. Operations may involve for example receiving a stream and generating another stream, or receiving a stream without generating a new stream, or generating a stream without receiving a stream or modifying a received stream. Processors 11a-c are able to process data streams generated by other ones of the processors 11a-c, or even streams that they have generated themselves. A stream comprises a succession of data objects which are transferred from and to the processors 11a-c via memory 10.

In order to read or write data from a data object, the processor 11a-c accesses a part of memory 10 that is allocated to the stream.

FIG. 3 depicts an illustration of the process of reading and writing and its associated synchronisation operations. From the coprocessor point of view, a data stream looks like an infinite tape of data having a current point of access. The getspace call issued from the coprocessor (computational unit) asks permission for access to a certain data space ahead of the current point of access as depicted by the small arrow in FIG. 3a. If this permission is granted, the coprocessor can perform read and write actions inside the requested space, i.e. the framed window in FIG. 3b, using variable-length data as indicated by the n_bytes argument, and at random access positions as indicated by the offset argument.

If the permission is not granted, the call returns false. After one or more getspace calls—and optionally several read/write actions—the coprocessor can decide if is finished with processing or some part of the data space and issue a putspace call. This call advances the point-of-access a certain number of bytes, i.e. n_bytes 2 in FIG. 3d, ahead, wherein the size is constrained by the previously granted space.

FIG. 4 shows a logical memory space 20 of the memory 10 that contains a series of memory locations that have logically successive addresses. FIG. 5 shows how two processors 11a and 11b exchange data objects via the memory 10. The memory space 20 contains subspaces 21, 22, 23 allocated to different streams. By way of example the subspace 22, which is bounded by the low boundary address LB and the high boundary address HB is shown in more detail in FIG. 4. In this subspace 22 the memory locations between the adresses A2 and A1, also indicated by section A2-A1 contain valid data, available for a reading processor 11b. The memory locations between the address A1 and the high boundary HB of the subspace, as well as those between the low boundary of the subspace LB and the address A2, indicated by section A1-A2 are available to the writing processor 11a for writing new data By way of example it is assumed that processor 11b accesses data objects stored in the memory locations allocated to a stream generated by the processor 11a.

In the example described above the data for a stream is written in a cyclical series of memory locations, starting at the logically lowest address LB each time a logically highest address HB has been reached. This is illustrated by the circular representation of the memory subspace in FIG. 5 wherein the lower boundary LB and the higher boundary HB are neighbouring each other.

Administration unit 18b ensures that the processor 11b does not access memory locations 22 before valid data for a processed stream has been written to these memory locations. Similarly, administration unit 18a is used here to ensure that the processor 11a does not overwrite useful data in memory 10. In the embodiment shown in FIG. 2, administration units 18a,b form part of a ring 18a,b,c, in which synchronization signals are passed from one processor 11a-c to the next, or blocked and overwritten when these signals are not needed at any subsequent processor 11a-c. The administration units 18a, 18b, 18c together form a synchronization channel. The administration units 18a maintain information about the memory space which is used for transferring the stream of data objects from processor 11a to processor 11b. In the embodiment shown administration unit 18a stores a value A1 which is representative for the start A1 of the address range of the section A1-A2 available to be written by processor 11a It also stores a value S1 which is representative for the size of that section. However the said address range might also be indicated by their boundaries, or by the upper boundary A2 and the value S1. Likewise, administration unit 18b stores a value A2 which is representative for the start A2 of the section A2-A1 which contains valid data for processor 11b. It also stores a value S2 which is representative for the size of that section. When processor 11a starts generating data for processor 11b, the size S2 of the section A2-A1 should be initialized at zero, as no valid data is available yet for the latter processor 11b. Before the processor 11a starts writing data into the memory subspace 22 it requests a section within this space by a first instruction C1 (getspace). A parameter of this instruction is the size n which is claimed. If a plurality of memory subspaces are available, it also includes a parameter for identifying the subspace. The subspace may be identified by an identification of the stream which is transferred via this subspace. As long as the claimed size n is less than or equal to the size S1 stored by administration unit 18a for the section, the latter 18a grants this request. The processor 11a can now write data objects to the portion A1-A2′ with size n of the section A1-A2 of the memory subspace to which it requested access.

If the required number n reaches beyond the indicated number S1, the generating processor 11a suspends processing of the indicated stream. The generating processor 11a may then take up processing for another stream that it is generating, or the generating processor 11a may pause processing altogether. If the required number reaches beyond the indicated number, the generating processor 11a will execute the instruction that indicates the required number of memory locations with new data again at a later time, until the generating processor 11a detects the event that the required number does not reach beyond the location indicated by the receiving processor 11a. After the detection of this event the generating processor 11a continues processing.

In order to synchronize, a generating processor 11a-c that generates a data stream sends an indication of the number of locations in memory 10 of which the data stream content has become valid, after this data stream content has become valid. In the present example, if the processor 11a has written data objects occupying a space m, it gives a second instruction C2 (putspace) indicating that said data objects are available to further processing by the second processor 11b. A parameter m of this instruction indicates the corresponding size of the section within memory subspace 22 which is released. A further parameter may be included to indicate the memory subspace. Upon receipt of this instruction the administration unit 18a reduces the available size S1 with m and increases the address A1:

A1=A1⊕m, wherein ⊕ is summation modulo HB-LB.

The administration unit 18a further sends a message M to the administration unit 18b of processor 11b. Upon receipt of this message the administration unit 18b increases the size S2 of A2-A1 with m. When the receiving processor, here 11b reaches a stage of processing of the stream where new data is needed, it sends an instruction C1 (k) that indicates the required number of memory locations k with new data. After the instruction the computational unit 12b of the receiving processor 11b continues processing if the response from the administration unit 18b indicates that this required number does not reach beyond the location indicated by the generating processor 11a.

If the required number k reaches beyond the indicated number S2, the receiving processor 11b suspends processing of the indicated stream. The receiving processor 11b may then take up processing of another stream that it is processing, or the receiving processor may pause processing altogether. If the required number k reaches beyond the indicated number S2, the receiving processor 11b will execute the instruction that indicates the required number of memory locations with new data again at a later time, until the event has been recorded in the receiving processor 11b that the required number k does not reach beyond the location A1 indicated by the generating processor 11a Upon recording this event the receiving processor 11b resumes processing the stream.

In the example described above the data for a stream is written in a cyclical series of memory locations, starting at the logically lowest address LB each time a logically highest address HB has been reached. This creates the possibility that the generating processor 11a catches up with the receiving processor and overwrites data that is still needed by the receiving processor. When it is desired to prevent that the generating processor 11a-c overwrites such data, the receiving processor 11a-c sends an indication of the number of memory locations in memory that it no longer needs each time after the receiving processor 11a-c has stopped processing content from these locations. This can be realized by means of the same instruction C2 (putdata) which is used by the generating processor 11a This instruction includes the number of memory locations m′ which it no longer needs. In addition it may contain an identification of the stream, and or the memory subspace if more than one stream is processed. Upon receipt of this instruction the administration unit 18b decreases the size S2 with m′, and increases the address A2 with m′ modulo the size of the memory subspace. The administration unit 18b also sends a message M′ to the administration unit 18a of the generating processor 11a. Upon receipt of this message the administration unit 18a of the generating processor 11a increases the size S1.

This means that data from a stream can be overwritten up to a current initial location 24a-c, indicated in FIG. 4 for a number of different streams. The indication is recorded in the generating processor 11a-c. When the generating processor 11a-c reaches a stage of processing where it needs to write data from the generated stream to a number of new locations in memory, the generating processor 11a-c executes a instruction that indicates the required number of memory locations needed for new data. After the instruction the generating processor 11a-c continues processing if the indication recorded by the generating processor 11a-c indicates that this required number does not reach beyond the location indicated by the receiving processor 11a-c.

Preferably, the number of locations with valid content and the number of locations that may be overwritten are indicated in terms of a number of standard locations, and not in terms of a number of data objects in the stream. This has the effect that the processors that generate and receive the data stream don't have to indicate validity or reusability of locations with the same block size. The advantage is that the generating and receiving processor 11a-c can each be designed without knowledge of the block size of the other processor 11a-c. A processor 11a-c that operates at a small block size need not wait for a processor that operates at a large block size.

The indication of the memory locations may be performed in several ways. One way is to indicate the number of additional memory locations that is valid or that may be overwritten. Another solution is to transmit the address of the last valid or overwriteable location.

Preferably, at least one of the processors 11a-c is capable of alternately operating on different streams. For each received stream the processor 11a-c locally keeps information about the location in memory up to which the data is valid and for each generated stream it keeps information about the location in memory up to which new data may be written.

The implementation and operation of the administration units 18a,b,c do not need to make differentiations between read versus write ports, although particular instantiations may make these differentiations. The operations implemented by the administration units 18a,b,c effectively hide implementation aspects such as the size of the FIFO buffer 22, its location in memory 20, any wrap-around mechanism on address for memory bound cyclic FIFO's, caching strategies, cache coherency, global I/O alignment restrictions, data bus width, memory alignment restrictions, communication network structure and memory organisation.

Preferably, the administration units 18a-c operate on unformatted sequences of bytes. There is no need for any correlation between the synchronisation packet sizes used by the writer 11a and a reader 11b which communicate the stream of data. A semantic interpretation of the data contents is left to the coprocessor, i.e. the computation unit 12a, 12b. The task is not aware of the application graph incidence structure, like which other tasks it is communicating to and on which coprocessors these tasks mapped, or which other tasks are mapped on the same coprocessor.

In high-performance implementations of the administration units 18a-c the read call, write call, getspace call, putspace calls can be issued in parallel via a read/write unit and a synchronisation unit comprised in the administration units 18a-c. Calls acting on the different ports of the administration unit 18a-c do not have any mutual ordering constraint, while calls acting on identical ports of the administration unit 18a-c must be ordered according to the caller task or coprocessor. For such cases, the next call from the coprocessor can be launched when the previous call has returned, in the software implementation by returning from the function call and in hardware implementation by providing an acknowledgement signal.

A zero value of the size argument, i.e. n_bytes, in the read call can be reserved for performing pre-fetching of data from the memory to the cache of the administration unit at the location indicated by the port_ID- and offset-argument. Such an operation can be used for automatic pre-fetching performed by the administration unit. Likewise, a zero value in the write call can be reserved for a cache flush request although automatic cache flushing is a responsibility of the administration unit.

Optionally, all five operations accept an additional last task_ID argument. This is normally the small positive number obtained as result value from an earlier gettask call. With a gettask call the coprocessor (computation unit) can request its administration unit to assign a new task, for example if the computation unit can not proceed with the current task, because insufficient data objects are available. Upon this gettask call the administration unit returns the identification of the new task. The zero value for this argument in the operations read, write, putspace and getspace is reserved for calls which are not task specific but relate to coprocessor control.

In the preferred embodiment the set-up for communicating a data stream is a stream with one writer and one reader connected to the finite-size of FIFO buffer. Such a stream requires a FIFO buffer which has a finite and constant size. It will be pre-allocated in memory and in its linear address range a cyclic addressing mechanism is applied for proper FIFO behaviour.

However in a further embodiment based on FIG. 2 and FIG. 6, the data stream produced by one task is to be consumed by two or more different consumers having different input ports. Such a situation can be described by the term forking. However, we want to re-use the task implementations both for multi-tasking hardware coprocessors as well as for software task running on the CPU. This is implemented through tasks having a fixed number of ports, corresponding to their basic functionality. Any needs for forking induced by application configuration are to be resolved by the administration unit.

Clearly stream forking can be implemented by the administration units 18a-c by just maintaining two separate normal stream buffers, by doubling all write and putspace operations and by performing an AND-operation on the result values of doubled getspace checks. Preferably, this is not implemented as the costs would include a double write bandwidth and probably more buffer space. Instead preferably, the implementation is made with two or more readers and one writer sharing the same FIFO buffer.

FIG. 6 shows an illustration of the FIFO buffer with a single writer and multiple readers. The synchronisation mechanism must ensure a normal pair wise ordering between A and B next to a pair wise ordering between A and C, while B and C have no mutual constraints, e.g. assuming they are pure readers. This is accomplished in the administration unit associated to the coprocessor performing the writing operation by keeping track of available space separately for each reader (A to B and A to C). When the writer performs a local getspace call its n_bytes argument is compared with each of these space values. This is implemented by using extra lines in said stream table for forking connected by one extra field or column to indicate changing to a next line.

This provides a very little overhead for the majority of cases where forking is not used and at the same time does not limit forking to two-way only. Preferably, forking is only implemented by the writer. The readers need not be aware of this situation.

In a further embodiment based on FIG. 2 and FIG. 7, the data stream is realised as a three station stream according to the tape-model. Each station performs some updates of the data stream which passers by. An example of the application of the three station stream is one writer, and intermediate watchdog and the final reader. In such example the second task preferably watches the data that passes and may be inspects some while mostly allowing the data to pass without modification. Relatively infrequently it could decide to change a few items in the stream. This can be achieved efficiently by in-place buffer updates by a processor to avoid copying the entire stream contents from one buffer to another. In practice this might be useful when hardware coprocessors communicate and a main CPU intervenes to modify the stream to correct hardware flaws, to do adaptation towards slightly different stream formats, or just for debugging reasons. Such a set-up could be achieved with all three processors sharing the single stream buffer in memory, to reduce memory traffic and processor workload. The task B will not actually read or write the full data stream.

FIG. 7 depicts a finite memory buffer implementation for a three-station stream. The proper semantics of this three-way buffer include maintaining a strict ordering of A, B and C with respect to each other and ensuring no overlapping windows. In this way the three-way buffer is a extension from the two-way buffer shown in FIGS. 4 and 5. Such a multi-way cyclic FIFO is directly supported by the operations of the administration units as described above as well as by the distributed implementation style with putspace messages as discussed in the preferred embodiment. There is no limitation to just three stations in a single FIFO. In-place processing where one station both consumes and produces useful data is also applicable with only two stations. In this case both tasks performing in-place processing to exchange data with each other and no empty space is left in the buffer.

In the further embodiment based on FIG. 2 the single access to buffer is described. Such a single access buffer comprises only a single port. In this example no data exchange between tasks or processors will be performed. Instead, it is merely an application of the standard communication operations of said administration units for local use. The set-up of the administration units consists of the standard buffer memory having a single access point attached to it The task can now use the buffer as a local scratchpad or cache. From the architectural point of view this can have advantages such as the combined uses of larger memory for several purposes and tasks and for example the use of the software configurable memory size. Besides the use as scratchpad memory to serve the task specific algorithm of this set-up is well applicable for storing and retrieving tasks states in the multi-tasking coprocessor. In this case performing read/write operations for state swapping is not part of the task functional code itself but part of the coprocessor control code. As the buffer is not used to communicate with other tasks it is normally no need to perform the put space and getspace operations on this buffer.

In a further embodiment based on FIG. 2 and FIG. 8, the administration units 18a-c according to the preferred embodiment further comprise a data cache for data transport, i.e. read operation and write operations, between the coprocessors 12 and the memory 20. The implementation of a data cache in the administration units 18a-c provide a transparent translation of data bus widths, a resolvement of alignment restrictions on the global interconnect, i.e. the data bus 13, and a reduction of the number of I/O operations on the global interconnect.

Preferably, the administration units 18a-c comprise separate read write interfaces each having a cache, however these caches are invisible from the application functionality point of view. Here, the mechanism of the putspace and getspace operations is used to explicitly control cache coherence. The caches play an important role in decoupling the coprocessor reads and write ports from the global interconnect of the communication network (data bus) 13. These caches have a major influence on the system performance regarding speed, power and area.

The access in a window of stream data which is granted to a task port is guaranteed to be private. As a result read and write operations in this area are save and at first side do not need intermediate intra-processor communication. The access window is extended by means of local getspace requests obtaining new memory space from a predecessor in the cyclic FIFO. If some part of the cache is tagged to correspond to such an extension and the task may be interested in reading the data in that extension then such part of the cache needs invalidation. If then later a read operation occurs on this location a cache miss occurs and fresh valid data is loaded into the cache. An elaborate implementation of the administration unit could use the getspace to issue the pre-fetch request to reduce cache miss penalty. The access window is shrunk by means of local putspace request leaving new memory space to a successor in the cyclic FIFO. If some part of such a shrink happens to be in the cache and that part has been written, then such part of the cache needs to be flushed to make the local data available to other processors. Sending the putspace message out to another coprocessor must be postponed until the cache flush is completed and safe ordering of memory operations can be guaranteed.

Using only local getspace and putspace events for explicit cache coherency control is relatively easy to implement in large system architectures in comparison with other generic cache coherency mechanisms such as a bus snooping. Also it does not provide the communication overhead like for instance a cache write-through architecture.

The getspace and putspace operations are defined to operate at byte granularity. A major responsibility of the cache is to hide the global interconnect data transfer size and the data transfer alignment restrictions for the coprocessor. Preferably, the data transfer size is set to 16 bytes on ditto alignment, whereas synchronised data quantities as small as 2 bytes may be actively used. Therefore, the same memory word or transferred unit can be stored simultaneously in the caches of different coprocessors and invalidate information is handled in each cache at byte granularity.

FIG. 8 shows a combination of processor 12 and a administration unit 18 for use in a processing system as shown in FIG. 2. The administration unit 18 shown in more detail comprises a controller 181, a first table (stream table) 182 comprising stream information and a second table (task table) 183 comprising task information. The administration unit 18 also comprises a cache 184 for the processor 12. The presence of the cache 184 in the synchronization interface 18 allows for a simple design of the cache and simplifies cache control. In addition one or more caches, such as an instruction cache may be present in the processor 12.

The controller 181 is coupled via an instructionbus Iin to the corresponding processor, i.e. 12a, for receiving instructions of the type C1, C2. A feedback line FB serves to give feedback to said processor, for example to grant a request for bufferspace. The controller has a message input line Min to receive a message from a preceeding administration unit in the ring. It also has a message output line Mout to pass a message to a succeeding administration unit. An example of a message which a administration unit may pass to its successor is that a portion of buffer memory is released. The controller 181 has address buses STA and TTA to select an address of the stream table 182 and of the task table 183 respectively. It further has data buses STD and TTD to read/write data to from these tables respectively.

The administration unit 18 tramits and receives synchronization information from the other processors (not shown in FIG. 3) and stores at least the received information. The administration unit 18 further comprises a cache memory 184 that serves to store a copy of the data from the data stream locally in the processor 12. The cache memory 184 is coupled via a local address bus 185 and a local data bus 186 to the processor 12. In principle, processor 12 may address cache memory 184 with addresses that refer to locations in the memory 10 of the processing system of FIG. 1. If cache memory 184 contains a valid copy of the content of the addressed data, the processor 12 accesses the location in cache memory 184 that contains the copy and memory 10 (FIG. 1) is not accessed. The processor 12 preferably is a specialized processor core designed to perform one type of operation, e.g. MPEG decoding, very efficiently. Processor cores in different processors in the system may have different specializations. The synchronization interface 18 and its cache memory 184 may be identical for all different processors, with just the cache memory size possibly being adapted to the needs of the processor 12.

In the data processing system according to the invention the synchronization means initiate a cache operation in response to a synchronization command. In this way cache coherence can be maintained with a minimum amount of additional cache control measures. Several embodiments of the invention are possible.

In a first embodiment the at least one processor is the second processor (the reading processor) which issues a synchronization command (inquiry) for requesting space comprising data objects generated by the first processor (the writing processor), and the cache operation is an invalidate operation.

As shown schematically in FIG. 9 the reading processor issuses a command a request command GetSpace. The synchronization means 18, here the administration unit 18 forming part of the processor 11 now returns a feedback signal FB indicating whether the requested space is within the space 10B which is committed by the writing processor. Furthermore, in this embodiment the administration unit will invalidate the memory transfer units of the cache memory 184 which overlap with the requested space. As a result the controller 181 will immediately prefetch valid data from the memory if it attempts to read data from the cache and detects that this data is invalid.

Three different situations may then occur, as is illustrated in FIG. 10. In this figure each of the situations assumes that the read request occurs on an empty cache 184 resulting in a cache miss. In the left half of the figures schematically the computation unit 12 and the cache 184 of a processor 11 are shown. The right half shematically shows a portion 184 of the cache which is involved when a read request R takes place. Also the portion of the memory 10 is shown from which the data for the cache is fetched.

FIG. 10A indicates the read request R that leads to fetching a memory transfer unit MTU in the cache 184, i.e. a word, which is entirely contained inside the granted window W. Clearly this whole word MTU is valid in memory and can be declared valid once it is loaded in the cache.

In the FIG. 10B the read request R has the result that a word MTU is fetched from the memory 10 into the cache 184 which partially extends beyond the space W acquired by the coprocessor but remains inside the space W2 that is locally administrated in the administration unit 18 as available. If only the getspace argument would be used this word MTU would become partially declared invalid and it would need to be re-read once the getspace window W is extended. However, if the actual value of available space W2 is checked the entire word can be marked as valid.

In FIG. 10C the read request R has the effect that the word MTU which is fetched from memory 10 into the cache 184 partially extends into space S which is not known to be saved and might still become written by some other processor. Now it is mandatory to mark the corresponding area S′ in the word MTU as invalid when it is loaded into the cache 184. If this part S′ of the word gets accessed later the word MTU needs to be re-read.

Furthermore a single read requess, see R′ in FIG. 10C, could cover more than one memory word either because it crosses the boundary between two successive words. This could also happen if the read interface of the coprocessor 12 is wider than the memory word. FIG. 10A-C shows memory words which are relatively large in comparison with the requested buffer space W. In practice the requested windows W would often be much larger, however in an extreme case the entire cyclic communication buffer could also be as small as a single memory word.

In the previous embodiment data is fetched from the memory into the cache at the moment that a read attempt takes place in the cache 184, and the data in the cache is found to be invalid In a second embodiment data is prefetched in the cache of the reading processor as soon as the reading processor issues a command for requesting space. It is then unncessary to first invalidate the data in the cache.

In a third embodiment data is prefetched in the cache of the reading processor as soon as the writing processor issues a command that it releases space in which it has written new data objects.

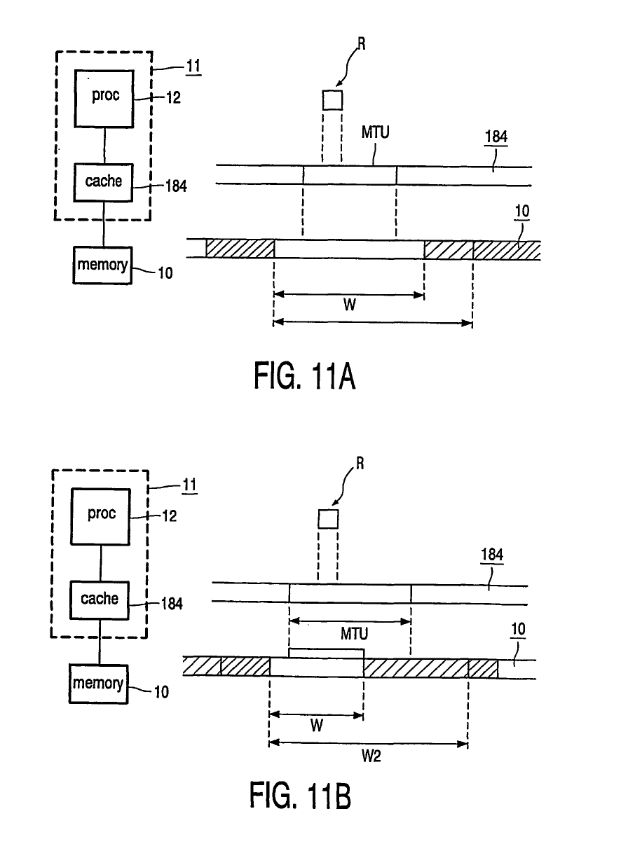

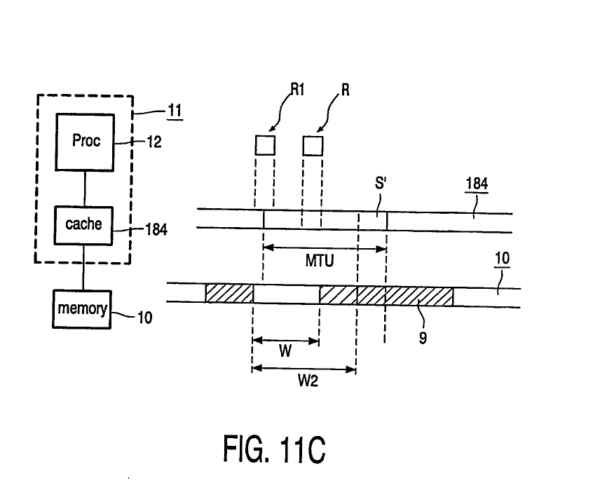

A fourth embodiment of the invention is suitable for maintaining cache coherency in the cache of the writing processor. This is achieved by performing a flush operation of said cache after that processor has given a commit operation. This is illustrated in FIG. 11. Therein part 10A of the memory is the space which is already committed by the writing processor. The PutSpace command indicates that the processor 12 releases space which is assigned to it and in which it has written new data objects. Cache coherency is now maintained by flushing the portions 184A, 184B of the cache 184 which overlap with the space which is released by the PutSpace command. A message to the reading processor that the space indicated by the PutSpace command has been released is delayed until the flush operation is complete. Also the coprocessors write data at byte granularity and cache administrates dirty bits per byte in the cache. Upon the putspace request the cache flushes those words from the cache to their shared memory which overlap with the address range indicated by this request. The dirty bits are to be used for the write mask in the bus write requests to assure that the memory is never written at byte positions outside the access window.

In a ‘Kahn’-style application of ports have dedicated direction, i.e either input or output Preferably, separated read and write caches are used which simplifies some implementation issues. As for many streams the coprocessors will linearly work through cyclic address space, the read caches optionally support pre-fetching and the write caches optionally support the pre-flushing, within two read access moves to the next word the cache location of the previous word can be made available for expected future use. Separate implementations of the read and write data path also more easily supports read and write requests from the coprocessor occurring in parallel for instance in a pipelined processor implementation.

Thus, the predictability of access to memory for a stream of data objects is used to improve cache management.

In the embodiment shown the synchronization message network between the sysnchronization interfaces is a token ring network. This has the advantage that it can be complied with a relatively small number of connections. Furthermore, the structure of token ring itself is scalable, so that a node can be added or deleted with little effect on interface design. However, in other embodiments the communication network may be implemented in different ways, e.g. as bus based network, or a switched matrix network, so as to minimize latency of synchronization.

In an embodiment, the first table 182 comprises the following information for a plurality of streams which is processed by the processor:
an address pointing to a location in the memory 10 where data should be written or read,
a value size indicating the size of the memory section within the memory available for buffering the stream of data between the communicating processor
a value space indicating the size of the portion of that section available to the processor coupled to the processor which is coupled to the administration unit,
a global identification gsid identifying the stream and the processor which is reading or writing this stream.

In an embodiment the second table 183 comprises the following information about the tasks which are performed:
an identification of one or more streams that are processed for said task,
a budget available for each task.
a task enable flag, indicating that the task is enabled or disabled,
a task runnable flag, indicating whether the task is ready to run or not,

Preferably the table 183 comprises for each task only one identification of a stream, for example the first stream of the task. Preferably the identification is an index into the stream table The administraton unit 18 may then simply calculate the corresponding id for other streams, by adding said index and a port number p. The port number can be passed as a parameter of an instruction given by the processor which is coupled to the administration unit.

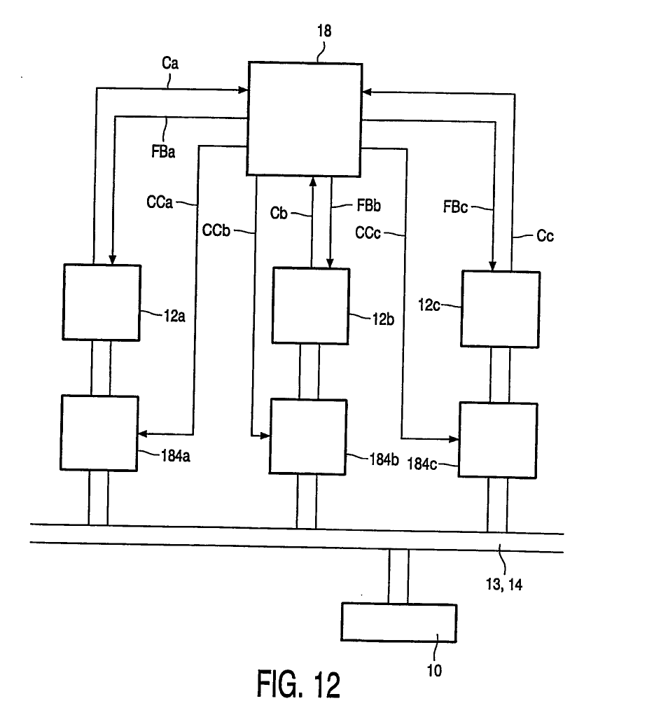

FIG. 12 shows an alternative embodiment. In this embodiment the processor sysnchronization means is a central unit which processes the commit and inquiry commands issued by the processors 12a, 12b, 12c. The processor synchronization means could be implemented in dedicated hardware, but could otherwise be a programmed general purpose processor. The processors 12a-c issue their synchronization commands Ca, Cb, Cc t the synchronization unit 18 and obtain feedback FBa, FBb, FBc. The synchronization unit 18 also controls the caches 184a, 184b, 184c by means of cache control commands CCa, CCb and CCc respectively. The processor 12a, 12b, 12c are coupled via their caches 184a, 184b, 184c and via data bus 13 and address bus 14 to a shared memory 10.

By way of example it is assumed that 12a is a writing processor and that 12c is a processor reading the data written by the writing processor. However, the role of each processor may be scheduled dynamically, dependent on the available tasks.

In this example, wherein processor 12a is the writing processor, the synchronization unit maintains coherency of cache 184a by issuing a flush command to cache 184a, after it receives a PutSpace command by the writing processor 12a. In a further embodiment of this embodiment the synchronization unit may also issue a prefetch command to the cache of the processor 12c which is reading the datastream of processor 12a The prefetch command has to be given after the flush command to cache 184a.

In another embodiment however cache coherence of the cache 184c of the reading processor 12c may be achieved independent of the activities of the writing processor 12a This can be achieved when the synchronization unit 18 issues an invalidate command to the cache 184c of the reading processor 12c upon receipt of a GetSpace command from that processor 12c. As a result of this command the portions of the said cache 184c overlapping with the area claimed by the GetSpace command are invalidated. Said portions are fetched from the memory 10 as soon as a read attempt takes place by the reading processor 12c. Also the sysnchronization unit 18 could issue a prefetch command to the cache 184c of the reading processor 12c so that the data is already available if the reading processor 12c actually starts to read.

1. A data processing system comprising
a memory,
a first and a second processor, the processors being connected to the memory, both arranged for carrying out a process on a stream of data objects, the first processor being arranged to pass successive data objects from the stream to the second processor by storing the data objects successively in the memory for readout by the second processor;
processor synchronization means, for synchronizing the processors when passing the stream of data objects,
the processors being capable of issuing synchronization commands to the synchronization means,
wherein at least one of the processors comprises a cache memory, and wherein the synchronization means initiate a cache operation in response to a synchronization commands.

2. A data processing system according to claim 1, characterized in that the at least one processor is the second processor which issues a synchronization command (inquiry) for requesting space comprising data objects generated by the first processor, and the cache operation being an invalidate operation.

3. A data processing system according to claim 1, characterized in that the at least one processor is the first processor which issues a command (commit) for releasing space which is assigned to it and in which it has written new data objects, and the cache operation being a flush operation.

4. A data processing system according to claim 1, characterized in that the at least one processor is the second processor which issues a command (inquiry) for requesting space, comprising data objects generated by the first processor and the cache operation being a prefetch operation.

5. A data processing system according to claim 1, characterized in that the at least one processor is the first processor which issues a command (commit) for releasing space which is assigned to it and in which it has written new data objects, the cache operation being a prefetch operation of the cache of the reading processor.
